(19) United States
(12) Patent Application Publication
(10) Pub. No.: US 2024/0327607 A1
(43) Pub. Date: Oct. 3, 2024

(54) MOISTURE CURABLE RESIN COMPOSITION

(71) Applicant: Kaneka Americas Holding, Inc., Pasadena, TX (US)

(72) Inventors: Jonathan Barrus, Pasadena, TX (US); Yoshiki Nakagawa, Pasadena, TX (US); Ruolei Wang, Pasadena, TX (US); Shota Koya, Pasadena, TX (US)

(73) Assignee: Kaneka Americas Holding, Inc., Pasadena, TX (US)

(21) Appl. No.: 18/621,474

(22) Filed: Mar. 29, 2024

Related U.S. Application Data
(60) Provisional application No. 63/455,926, filed on Mar. 30, 2023.

(51) Int. Cl. C08K 5/00; B01J 31/04

(52) U.S. Cl. CPC C08K 5/0016; B01J 31/04; C08K 5/0025; C08K 2201/002; C08K 2201/019

(57) ABSTRACT

A curable resin composition includes 10 wt % to 70 wt % of at least one moisture curable resin, 10 wt % to 50 wt % of a plasticizer having a Brookfield viscosity of less than 25 cP at 23° C., and 0.1 wt % to 5 wt % of a non-tin catalyst. A method for producing a curable resin composition includes mixing 10 wt % to 70 wt % of at least one moisture curable resin, 10 wt % to 50 wt % of a plasticizer, and 0.1 wt % to 5 wt % of a non-tin catalyst.

### BACKGROUND

A moisture-curable resin composition is often used as a coating material to protect a structure. Such compositions may include a moisture curable resin, a catalyst, and a plasticizer. A composition which includes glycol esters as the plasticizer generally exhibits cure retardation, as a result of the glycol ester undergoing transesterification reaction and forming long-chain alcohols.

Furthermore, a moisture-curable resin composition containing organotin catalysts, such as dibutyltin catalyst, is considered a hazardous material, which requires proper hazardous substance control measures and appropriate labelling. Such requirements may result in additional labor and have negative financial impact.

Some plasticizers, such as benzoate plasticizers, have low viscosity and are considered non-volatile organic compounds (having a boiling point of greater than 260° C.). Such plasticizers may allow production of a sprayable resin composition that is substantially free of volatile organic compounds. However, such plasticizers are generally not used with a moisture curable resin containing organotin catalysts because generation of methyl benzoate occurs when organotin is mixed with benzoate and methanol, which may result from methoxysilane in the polymer being in equilibrium with trace moisture. Methyl benzoate exhibits noxious odor, which may be overwhelming to the user of the resin system and bothersome to those exposed to the cured or uncured resin system, such as an occupant of a building with walls coated with the resin system. Accordingly, there exists a need for continuing improvement of a moisture curable resin composition.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a curable resin composition, including 10 wt % to 70 wt % of at least one moisture curable resin, with 10 wt % to 50 wt % of a plasticizer having a Brookfield viscosity of less than 25 cP at 23° C., and 0.1 wt % to 5 wt % of a non-tin catalyst.

In another aspect, embodiments disclosed herein relate to a method for producing a curable resin composition, comprising mixing 10 wt % to 70 wt % of at least one moisture curable resin, 10 wt % to 50 wt % of a plasticizer, and 0.1 wt % to 5 wt % of a non-tin catalyst.

Other aspects and advantages of the claimed subject matter will be apparent from the following description and the appended claims.

### DETAILED DESCRIPTION

### Curable Resin Composition

The present disclosure generally relates to a curable resin composition. The curable resin composition includes at least one moisture curable resin, a plasticizer, and a non-tin catalyst.

### Moisture Curable Resin

In one or more embodiments, the curable resin composition includes at least one moisture curable resin. The moisture curable resin may be a polymer containing functional groups that are reactive with moisture or water. In one or more embodiments, the moisture curable resin includes reactive silicone groups, such as silyl-terminated polyether and/or silane-terminated polyurethane.

A specific structure of the reactive silicon groups is not specifically limited, but may include reactive silicon groups represented by the general formula (1):

—Si(R¹₃₋ₐ)Xₐ . . . (1)

where R¹ represents an alkyl group having 1 to 20 carbon atoms, an aryl group having 6 to 20 carbon atoms, or an aralkyl group having 7 to 20 carbon atoms; X represents a hydrolyzable group, wherein each X is the same or different when two or more X are present; a is an integer from 1 to 3, wherein, when a is 1, each R¹ may be the same or different, and when a is 2 or 3, each X may be the same or different.

In one or more embodiments, the moisture curable resin includes trimethoxysilyl, methyldimethoxysilyl, triethoxysilyl, methyldiethoxysilyl groups, or combinations thereof.

Specific examples of the moisture curable resin may include, but are not limited to, one or more of KANEKA MS POLYMER® S327, S227, S203H, and S303H, and KANEKA SILYL® MA904, SAX220, SAX350, SAX530, SAX400, SAX590, SAT145, and SAT115.

The moisture curable resin may have a number of the reactive silicone groups in a range of from about 0.5 to about 6 per single polymer chain, such as a lower limit selected from any one of 0.5, 0.6, 0.7, 0.8, 0.9, 1.0, and 1.1, to an upper limit selected from any one of 3, 4, 5, and 6, where any lower limit may be paired with any upper limit.

The moisture curable resin may have linear or branched structures, and the number-average molecular weight (Mn) may be in a range of from about 500 to about 100,000, such as a lower limit selected from any one of 500, 1000, 2000, and 3000 to an upper limit selected from any one of 10,000, 15,000, 50,000, and 100,000 where any lower limit may be paired with any upper limit. The Mn may be measured with the use of HLC-8120GPC (TOSOH CORPORATION) as a solution-sending system, TSK-GEL H type column (TOSOH CORPORATION), and THF solvent.

The moisture curable resin may have a molecular weight distribution (Mn/Mw), or a ratio of Mn and weight-average molecular weight (Mw), of 1.6 or less, such as 1.6 or less, 1.4 or less, or 1.2 or less.

The reactive silicone group of the moisture curable resin may be bonded to a terminal end of the polymer chain or along the polymer chain between the terminal ends, or a plurality of the reactive silicone groups may be bonded to both the terminal ends and along the polymer chain.

The number of the reactive silicon groups in a single polymer chain of the moisture curable resin may be 0.5 or more on average, or 1 or more on average; or they may be in a range of from about 0.5 to 6, such as in a range of from a lower limit selected from any one of 0.5, 0.6, 0.7, 0.8, 0.9, 1.0, and 1.1, to an upper limit selected from any one of 3, 4, 5, and 6, where any lower limit may be paired with any upper limit.

In one or more embodiments, the amount of the moisture curable resin in the curable resin composition is in a range of from about 10 wt % to about 70 wt %, such as a lower limit selected from any one of 10, 20, and 30 wt %, to an upper limit selected from any one of 50, 60, and 70 wt %, where any lower limit may be paired with any upper limit.

### Plasticizer

In one or more embodiments, the curable resin composition includes at least one plasticizer. Suitable plasticizer(s) may include, but are not limited to, benzoate, phthalates, cyclohexyl diesters, glycol diester, petroleum distillate, and combinations thereof. Benzoate plasticizers may include isodecyl benzoate (e.g., Jayflex™ MB10 (“MB10”) available from ExxonMobil). Glycol diester plasticizers may include tri (ethylene glycol)bis(2-ethylhexanoate) “TEG-EH)” (e.g. Oxfilm 351 available from OQ Chemicals), phthalates may include diisononyl phthalates (e.g., Jayflex™ DINP), cyclohexyl diesters may include 1,2-cyclohexane dicarboxylic acid diisononyl ester (e.g. Hexamoll™ DINCH available from BASF), and petroleum distillate plasticizers may include Fluid D 170 LPP (available from TotalEnergies).

In one or more embodiments, the plasticizer is used alone or used in combinations with at least one higher viscosity plasticizer (plasticizer blend). The higher viscosity plasticizer refers to a plasticizer having a Brookfield viscosity of at least 25 cP at 23° C. The plasticizer or at least one plasticizer in the plasticizer blend contained in the curable resin composition may have a dynamic viscosity of less than 25 cP at 23° C., when measured with a rotational, or a Brookfield viscometer (“Brookfield viscosity”). In one or more embodiments, the plasticizer has a viscosity in a range of from about 1 cP to about 25 cP at 23° C., such as a lower limit selected from any one of 1, 2, 4, 5 cP, to an upper limit selected from any one of 15, 20 and 25 cP, where any lower limit may be paired with any upper limit. For example, MB10, D 170 LPP, and TEG-EH may have a dynamic viscosity of 13 cP, 15 cP, and 17 cP respectively, when measured with a Brookfield LV viscometer with an RV-01 spindle at a temperature of 23° C. and at 12 revolutions per minute (rpm).

In one or more embodiments, the amount of the plasticizer in the curable resin composition is in a range of from about 5 wt % to about 50 wt %, such as a lower limit selected from any one of 5, 10, and 20 wt %, to an upper limit selected from any one of 30, 40, and 50 wt %, where any lower limit may be paired with any upper limit.

In one or more embodiments, a content of the moisture curable resin and the plasticizer in the curable resin compositions is in a range of about 20 wt % to about 90 wt % of the curable resin composition, such as a lower limit selected from any one of 20, 30, and 40 wt %, to an upper limit selected from any one of 70, 80, and 90 wt %, where any lower limit may be paired with any upper limit.

In one or more embodiments, the plasticizer is substantially free of volatile organic compounds. A plasticizer “substantially free” of volatile organic compounds refers to a plasticizer having volatile organic compounds of about less than 5 wt % of the total weight of the plasticizer, such as having less than 5, 4, 3, 2, 1, 0.5, 0.1, 0.05, or 0.01 wt % of volatile organic compounds based on the total weight of the plasticizer. In one or more embodiments, the plasticizer contains 0 wt % volatile organic compounds based on the total weight of the plasticizer.

In one or more embodiments, the plasticizer has a boiling point of at least 260° C., or in a range from about 260° C. to about 500° C., such as in a range from a lower limit selected from any one of 260, 270, 280, 290, and 300° C. to an upper limit selected from any one of 400, 410, 420, 430, 440, 450, and 500° C., where any lower limit may be paired with any upper limit.

### Non-Tin Catalyst

In one or more embodiments, the curable resin composition includes a non-tin catalyst. A “non-tin” catalyst refers to a catalyst which contains no tin or no compounds containing tin, such as organotin compounds. Suitable non-tin catalysts may include, but are not limited to, a carboxylic acid metal salt catalyst, such as potassium neodecanoate (e.g., “TIB KAT® K25” available from TIB Chemicals AG), a zinc complex (e.g. “K-KAT 670” available from King Industries), and a titanium complex, such as diisopropoxy-bisethylacetoacetatotitanate (e.g., “Tyzor® PITA” available from Dorf Ketal). As described previously, a combination of benzoate, organotin and methanol may generate methyl benzoate, and the use of non-tin catalysts allows the use of benzoate plasticizers in a moisture curable resin (such as silyl-terminated polymer) without the concern of noxious odor generation.

In one or more embodiments, the amount of the non-tin catalyst in the curable resin composition is in a range of from about 0.1 wt % to about 5 wt %, such as a lower limit selected from any one of 0.1, 0.5, and 1 wt %, to an upper limit selected from any one of 4, 4.5, and 5 wt %, where any lower limit may be paired with any upper limit.

### Additives

In one or more embodiments, the curable resin composition includes additives. The curable resin composition may include any suitable additives, such as fillers, pigments, thixotropic agents (anti-sagging agents), UV inhibitors/absorbers, stabilizers, antioxidants, dehydration agents, adhesion promoters, flame retardants, curability modifiers, lubricants, antifungal agents, and combinations thereof.

Examples of the fillers may include, but are not limited to, ground and precipitated calcium carbonate (CaCO₃), magnesium carbonate, diatomite, calcined clay, clay, talk bentonite, reinforcing fillers such as fumed silica, precipitated silica, crystalline silica, and fibrous fillers such as glass fibers and filaments.

Examples of pigments may include, but are not limited to, titanium dioxide (TiO₂) and carbon black.

Examples of thixotropic agents may include, but are not limited to, hydrogenated castor oil, organic amid wax, organic bentonite, and calcium stearate.

Examples of UV inhibitors/absorbers may include, but are not limited to, benzophenone compounds, benzotriazole compounds, traizine compounds, salicylate compounds, substituted tolyl compounds, and metal chelate compounds.

Examples of stabilizers may include, but are not limited to, hindered amine light stabilizer (HALS), benzotriazole compounds, and benzoate compounds.

Examples of antioxidants may include, but are not limited to, hindered phenolic antioxidants such as Irganox®245, 1010, and 1076, (available from BASF).

Examples of dehydration agents may include, but are not limited to, alkoxysilane compounds such as n-propyl trimethoxy silane, vinyl trimethoxy silane and octyl trimethoxy silane.

Examples of adhesion promotors may include, but are not limited to, silane coupling agents; reaction products of silane coupling agents, such as isocyanate-group-containing silanes, amino-group-containing silanes (aminosilane), mercapto-group-containing silanes, epoxy-group-containing silanes, vinylically unsaturated group containing silanes, and halogen-containing silanes; amino-modified-silyl polymers; unsaturated aminosilane complexes; phenylamino long chain alkyl-silanes; aminosilylated silicones; and silylated polyesters.

In one or more embodiments, the curable resin composition further includes additional catalysts. Examples of additional catalysts may include amine compounds such as aliphatic primary amines, aliphatic secondary amines, aliphatic tertiary amines, and aliphatic unsaturated amines; nitrogen-containing heterocyclic compounds such as pyridine, imidazole; and amidines such as 1,8-diazabicyclo (5,4,0) undecane-7 (DBU).

In one or more embodiments, the amount of the additives in the curable resin composition is in a range of from about 0 wt % to about 50 wt %, such as a lower limit selected from any one of 0, 1, 5, 10, and 20 wt %, to an upper limit selected from any one of 30, 40, and 50 wt %, where any lower limit may be paired with any upper limit.

In one or more embodiments, the amount of the filler in the curable resin composition is in a range of from about 0 wt % to about 50 wt %, such as a lower limit selected from any one of 0, 1, 5, and 10 wt %, to an upper limit selected from any one of 40, 45, and 50 wt %, where any lower limit may be paired with any upper limit.

In one or more embodiments, the amount of the pigment in the curable resin composition is in a range of from about 0 wt % to about 10 wt %, such as a lower limit selected from any one of 0, 0.1, 0.2, 0.3, 0.4, and 0.5 wt %, to an upper limit selected from any one of 6, 7, 8, 9, and 10 wt %, where any lower limit may be paired with any mathematically compatible upper limit.

In one or more embodiments, the amount of the thixotropic agent in the curable resin composition is in a range of from about 0 wt % to about 4 wt %, such as a lower limit selected from any one of 0, 0.1, and 0.2 wt %, to an upper limit selected from any one of 1, 1.5, 1.7, 2, 3, 3.9, and 4 wt %, where any lower limit may be paired with any upper limit.

In one or more embodiments, the amount of the stabilizer in the curable resin composition is in a range of from about 0 wt % to about 3 wt %, such as a lower limit selected from any one of 0, 0.1, and 0.2 wt %, to an upper limit selected from any one of 0.5, 1, 2, and 3 wt %, where any lower limit may be paired with any upper limit.

In one or more embodiments, the amount of the dehydration agent in the curable resin composition is in a range of from about 0 wt % to about 3 wt %, such as a lower limit selected from any one of 0, 0.1, and 0.2 wt %, to an upper limit selected from any one of 0.5, 1, 2 and 3 wt %, where any lower limit may be paired with any upper limit.

In one or more embodiments, the amount of the adhesion promoter in the curable resin composition is in a range of from about 0 wt % to about 5 wt %, such as a lower limit selected from any one of 0, 0.1, and 0.5 wt %, to an upper limit selected from any one of 2, 3, 4, and 5 wt %, where any lower limit may be paired with any upper limit.

### Properties—Curable Resin Composition

In one or more embodiments, the curable resin composition has a viscosity of less than 150,000 cP at 1 rpm, as measured by a rotational viscometer. The viscosity of the curable resin composition by a rotational viscometer (Brookfield RV viscometer) is measured at a temperature of 23° C. with RV-06 spindle. In one or more embodiments, the curable resin composition has a viscosity in a range of from about 20,000 to about 150,000 cP at 1 rpm, as measured by a rotational viscometer, such as in a range of from a lower limit selected from any one of 20,000, 25,000, and 30,000 cP, to an upper limit selected from any one of 130,000, 140,000, and 150,000 cP, where any lower limit may be paired with any upper limit.

In one or more embodiments, the curable resin composition has a viscosity of less than 75,000 cP at 2 rpm, as measured by a rotational viscometer under the conditions as described previously. In one or more embodiments, the curable resin composition has a viscosity in a range of from about 20,000 to about 75,000 cP at 2 rpm, as measured by a rotational viscometer, such as in a range of from a lower limit selected from any one of 20,000, 25,000, and 30,000 cP, to an upper limit selected from any one of 60,000, 65,000 70,000, and 75,000 cP, where any lower limit may be paired with any upper limit.

In one or more embodiments, the curable resin composition has a viscosity of less than 25,000 cP at 10 rpm, as measured by a rotational viscometer under the conditions as described previously. In one or more embodiments, the curable resin composition has a viscosity in a range of from about 5,000 to about 25,000 cP at 10 rpm, as measured by a rotational viscometer, such as in a range of from a lower limit selected from any one of 5,000, 6,000, and 7,000 cP, to an upper limit selected from any one of 20,000, 22,000, 24,000, and 25,000 cP, where any lower limit may be paired with any upper limit.

In one or more embodiments, the curable resin composition has a viscosity of less than 3.5 Pas at a temperature of 25° C. and a shear rate of 1000 1/s, as measured by a parallel plate rheometer. In one or more embodiments, the curable resin composition has a viscosity in a range of about 1.0 to about 3.5 Pa's at a temperature of 25° C. and a shear rate of 1000 1/s, as measured by a parallel plate rheometer, such as in a range of from a lower limit selected from any one of 1.0, 1.25, and 1.5 Pa's to an upper limit selected from any one of 3.25 and 3.5 Pa's, where any lower limit may be paired with any upper limit.

In one or more embodiments, the curable resin composition has a thixotropic index of at least about 2.0. A “thixotropic index,” or a Brookfield thixotropic index, refers to a ratio of the viscosity of a composition at 2 rpm as measured by a rotational viscometer and the viscosity of the same composition at 10 rpm as measured by a rotational viscometer. In one or more embodiments, the curable resin composition has a thixotropic index in a range of from about 2.0 to about 4.0, such as in a range from a lower limit selected from any one of 2.0, 2.2, 2.3, 2.4, 2.5, and 2.6 to an upper limit selected from any one of 3.6, 3.7, 3.8, 3.9, and 4.0, where any lower limit may be paired with any upper limit.

In one or more embodiments, the curable resin composition has a skin time of less than 150 minutes at 23° C. and 50% relative humidity (RH). A “skin time” refers to a time required for the curable resin composition exposed to moisture-containing air to develop a film on the surface exposed to the air. In one or more embodiments, the curable resin composition has a skin time at 23° C. and 50% RH in a range from about 10 minutes to about 150 minutes, such as in a range of from a lower limit selected from any one of 10, 20, 30, and 40 minutes, to an upper limit selected from any one of 130, 140, and 150 minutes, where any lower limit may be paired with any upper limit.

In one or more embodiments, the curable resin composition has a skin time of less than 150 minutes at 23° C. and 50% RH, after the curable resin composition is stored for 4 weeks at 50° C. In one or more embodiments, the curable resin composition has a skin time at 23° C. and 50% RH, after 4-week storage at 50° C., in a range from about 10 minutes to about 150 minutes, such as in a range of from a lower limit selected from any one of 10, 20, 30, and 40 minutes, to an upper limit selected from any one of 130, 140, and 150 minutes, where any lower limit may be paired with any upper limit.

In one or more embodiments, the curable resin composition is sprayable at a pressure of 4000 psi or less without the use of volatile organic compounds. Volatile organic compounds refer to organic compounds having a boiling point of less than 260° C. The spray-ability of the curable resin composition is determined by using, for example, an airless hydraulic spray rig or a pressurized canister.

In one or more embodiments, the curable resin composition has a specific gravity (SG) in a range of from about 1.10 to about 1.60, such as in a range of from a lower limit selected from any one of 1.10 and 1.15, to an upper limit selected from any one of 1.40, 1.50 and 1.60, where any lower limit may be paired with any upper limit.

The specific gravity of the curable resin composition may be determined by multiplying the SG of each component and the weight % of each component in the curable resin composition to obtain fractional SG for each component, obtaining the sum of the fractional SG for all components, and dividing 1 by the sum of the fractional SG.

In one or more embodiments, the curable resin composition has a spray index (SI) determined by the following Formula (1):

$$SI = µ * SG / TI \qquad ( 1 )$$

where μ is the dynamic viscosity in Pa's determined at a shear rate of 1000 s⁻¹, SG is the specific gravity, and TI is the thixotropic index calculated by the 2 rpm/10 rpm Brookfield viscosity.

The dynamic viscosity of the curable resin composition, in Pa·s, (μ) is measured using a parallel plate rheometer. The parallel plates are 15 mm in diameter and are adjusted to a 0.5 mm gap. The viscosity of the curable resin composition is obtained at 25° C. and a shear rate of 1000 s⁻¹.

The spray index (SI) provides an indication whether the curable resin composition can be sprayed easily or not. A lower spray index generally indicates that the curable resin composition is easier to spray. In one or more embodiments, the curable resin composition, which is sprayable, has an SI of 2.0 or less. In one or more embodiments, the curable resin composition has an SI in a range from about 0.1 to about 2.0, such as a lower limit selected from any one of 0.1, 0.2, 0.3, 0.4, or 0.5 to an upper limit selected from any one of 1.3, 1.5, 1.6, 1.7, 1.8, 1.9, and 2.0, where any lower limit may be paired with any upper limit.

In one or more embodiments, the curable resin composition is substantially free of noxious odor. As noted previously, the curable resin composition containing a non-tin catalyst allows the use of benzoate plasticizers in a moisture curable resin, such as silyl-terminated polymer, without the concern of noxious odor generated by the formation of methyl benzoate.

### Properties—Cured Resin Composition

The present disclosure generally relates to a cured resin composition of the curable resin composition. The curable resin composition may be cured by being exposed to moisture to produce the cured resin composition, whereby the liquid composition cures into a substantially solid, elastomeric rubber coating.

In one or more embodiments, the cured resin composition of the curable resin composition has a permeability of more than 0.2 perm*inch when tested according to ASTM E96. In one or more embodiments, the cured resin has a permeability in a range of from about 0.2 to about 0.8, such as in a range of from a lower limit selected from any one of 0.20, 0.22, 0.25, 0.26, 0.28, and 0.3, to an upper limit selected from any one of 0.7 and 0.8, where any lower limit may be paired with any upper limit.

In one or more embodiments, the cured resin composition of the curable resin composition has a specific gravity in a range of from about 1.10 to about 1.60, such as in a range of from a lower limit selected from any one of 1.10 and 1.15, to an upper limit selected from any one of 1.40, 1.50, and 1.60, where any lower limit may be paired with any upper limit.

The specific gravity of the cured resin composition may be determined by dividing the wt % of each component by the SG of each component in the cured resin composition to obtain fractional SG for each component, obtaining the sum of the fractional SG for all components, and dividing 1 by the sum of the fractional SG.

In one or more embodiments, the cured resin composition of the curable resin composition is substantially free of noxious odor. As noted previously, the cured resin composition including a non-tin catalyst allows the use of benzoate plasticizers in a moisture curable resin, such as silyl-terminated polymer, without the concern of noxious odor generated by the formation of methyl benzoate.

### Structure

The present disclosure generally relates to a structure including a substrate and a membrane disposed on the sheathing structure. The membrane may include at least one layer of the cured resin composition of the curable resin composition as previously described, and the number of layers may be determined based on the requirements of each application. In one or more embodiments, the membrane includes a single layer of the cured resin composition. The single layer of the cured resin composition may function as a primer and a base coat. In one or more embodiments, the membrane includes a top coat disposed on the single layer of the cured resin composition. The top coat may be disposed on the surface that is opposite from the surface in contact to the substrate.

Examples of the substrate may include, but are not limited to, a fiberboard, oriented strand board (OSB) plywood, gypsum board, or other types of building sheathing board for residential, commercial, and institutional construction.

### A Method for Producing a Curable Resin Composition

In another aspect, embodiments disclosed herein relate to a method for producing a curable resin composition. The method may include mixing about 10 wt % to about 70 wt % of at least one moisture curable resin, about 10 wt % to about 50 wt % of a plasticizer, and about 0.1 wt % to about 5 wt % of a non-tin catalyst.

The mixing may be conducted with a method and equipment known in the art. In one or more embodiments, the mixing is conducted using single shaft or multiple shaft mixers, e.g. double planetary or disperser/anchor geometries.

The mixing may be conducted at a batch temperature in a range of from about 30° C. to 120° C., and at a relative humidity of about 10% to 85%. The mixing may be conducted under vacuum.

### A Method for Coating a Substrate

In another aspect, embodiments disclosed herein relate to a method for coating a substrate with the cured resin composition of the curable resin composition. The method includes, but is not limited to, providing a curable resin composition and spraying the curable resin composition onto a substrate.

The curable resin composition may be produced as previously described. The spraying may be conducted with a method and equipment known in the art. In one or more embodiments, the spraying may be conducted with an airless hydraulic spray rig or using a pressurized canister. The airless hydraulic spray rig may have a tip orifice size in a range of from about 0.017 to about 0.021. Examples of the airless hydraulic spray rig may include, but are not limited to, Graco X-Force handheld spray gun with 621 tip and 519 tip.

In one or more embodiments, the spraying is conducted at a pressure of equal to or less than 4000 psi, without including volatile organic compounds to the curable resin composition. In one or more embodiments, the spraying is conducted at a pressure in a range of about 50 psi to about 4000 psi, such as in a range from a lower limit selected from any one of 50, 100, and 500 psi to an upper limit selected from any one of 3000, 3500, and 4000 psi, where any lower limit may be paired with any upper limit.

In one or more embodiments, the method further includes exposing the sprayed curable resin composition to moisture, and curing the sprayed curable resin composition at least until substantially cured, to produce a cured resin composition of the curable resin composition. A “substantially cured” resin composition refers to a resin composition which has undergone a curing process such that no material transfer occurs upon handling with force, and the material develops the majority of targeted mechanical properties such as tensile strength, tensile, and hardness. A substantially cured resin composition may have a degree of cure of at least 50%, at least 60%, at least 70%, or at least 80%.

In one or more embodiments, the sprayed curable resin composition is exposed to air containing moisture. The air may have an RH in a range of about 25% to about 99%.

In one or more embodiments, the curing is conducted for a duration of at least 5 minutes, 10 minutes, 20 minutes, 30 minutes, 50 minutes, 100 minutes, or 150 minutes. In one or more embodiments, the curing is conducted for a duration in a range from about 5 minutes to about 10 days, such as in a range of from a lower limit selected from any one of 5 minutes, 10 minutes, 20 minutes, 30 minutes, 50 minutes, 100 minutes, and 150 minutes, to an upper limit selected from any one of 500 minutes, 1000 minutes, 1 day, 5 days, and 10 days, where any lower limit may be paired with any upper limit.

In one or more embodiments, the curing may be conducted in a controlled manner (“controlled curing”). Controlled curing refers to curing of the curable resin composition under conditions in which at least one parameter that affects the cure kinetics is controlled. Such parameters may include temperature and relative humidity. It is understood that the curable resin composition does not necessarily undergo controlled curing, depending on the application, and parameters such as temperature, relative humidity, and the time required to cure the resin may have varying ranges. The controlled curing may be conducted at room temperature, such as about 23° C., and controlled humidity, such as about 50% relative humidity. In one or more embodiments, the controlled curing is conducted at an elevated temperature, such as 50° C., to accelerate full cure.

The controlled curing may be conducted for a duration of at least 5 minutes, 10 minutes, 20 minutes, 30 minutes, 50 minutes, 100 minutes, or 150 minutes. In one or more embodiments, the controlled curing is conducted for a duration in a range from about 5 minutes to about 10 days, such as in a range of from a lower limit selected from any one of 5 minutes, 10 minutes, 20 minutes, 30 minutes, 50 minutes, 100 minutes, and 150 minutes, to an upper limit selected from any one of 500 minutes, 1000 minutes, 1 day, 5 days, and 10 days, where any lower limit may be paired with any upper limit.

In one or more embodiments, the curing of the curable resin composition does not generate methyl benzoate and does not generate any appreciable noxious odor as a result of the catalyst contained in the composition being a non-tin catalyst.

The spraying, exposing, and curing steps may be conducted once, or may be repeated, to produce a structure (including a substrate) and a membrane (including at least one layer of the cured resin composition) of the curable resin composition.

### EXAMPLES

The following examples are provided to illustrate embodiments of the present disclosure. The Examples are not intended to limit the scope of the present invention, and they should not be so interpreted.

Curable resin compositions EXAMPLES 1-11 (EX 1-11) and COMPARATIVE EXAMPLES (CE 1-9) were produced by mixing moisture curable resin(s), plasticizer(s), catalyst(s), and various additives as shown in Tables 1-1 to 1-3. And 2-1 to 2-3.

TABLE 1

| | | EX1 | | EX2 | | EX3 | | EX4 | |
|---|---|---|---|---|---|---|---|---|---|
| Component | | phr | wt % | phr | wt % | phr | wt % | phr | wt % |
| DMS MS Polymer | | 100 | 40.00% | 100 | 41.71% | 100 | 37.07% | 100 | 33.36% |
| TMS MS Polymer | | | | | | | | | |
| Plasticizer | A | | | | | | | | |
| | B | 40 | 16.00% | 40 | 16.68% | 40 | 14.38% | 40 | 13.34% |
| | C | 40 | 16.00% | 30 | 12.51% | 30 | 11.12% | 30 | 10.01% |
| | D | | | | | | | | |
| | E | | | | | | | | |
| | F | | | | | | | | |
| | G | | | | | | | | |
| Precipitated CaCO₃ | | 50 | 20.00% | 50 | 20.86% | 50 | 18.54% | 50 | 16.68% |
| Ground CaCO₃ | A | | | | | 30 | 11.12% | 60 | 20.02% |
| | B | | | | | | | | |
| Titanium Dioxide | | 5 | 2.00% | 5 | 2.09% | 5 | 1.85% | 5 | 1.67% |
| Carbon Black | | | | | | | | | |
| Thixotropic agent | | 1 | 0.40% | 0.75 | 0.31% | 0.75 | 0.28% | 0.75 | 0.25% |
| UV absorber | | 1 | 0.40% | 1 | 0.42% | 1 | 0.37% | 1 | 0.33% |
| HALS | | 1 | 0.40% | 1 | 0.42% | 1 | 0.37% | 1 | 0.33% |
| Dehydration agent | | 3 | 1.20% | 3 | 1.25% | 3 | 1.11% | 3 | 1.00% |
| Adhesion promoter | | 3 | 1.20% | 3 | 1.25% | 3 | 1.11% | 3 | 1.00% |
| Catalyst | A | | | | | | | | |
| | B | 6 | 2.40% | 6 | 2.50% | 6 | 2.22% | 6 | 2.00% |
| | C | | | | | | | | |
| | D | | | | | | | | |

| | | | | | | | | |
|---|---|---|---|---|---|---|---|---|
| Total | 250 | 100% | 239.75 | 100% | 269.75 | 100% | 299.75 | 100% |

| | | EX5 | | EX6 | | EX7 | | EX8 | |
|---|---|---|---|---|---|---|---|---|---|
| Component | | phr | wt % | phr | wt % | phr | wt % | phr | wt % |
| DMS MS Polymer | | 60 | 20.02% | 100 | 37.04% | 100 | 51.95% | 100 | 37.04% |
| TMS MS Polymer | | 40 | 13.34% | | | | | | |
| Plasticizer | A | | | | | | | | |
| | B | 40 | 13.34% | 40 | 14.81% | 40 | 20.78% | 40 | 14.81% |
| | C | 30 | 10.01% | 30 | 11.11% | 30 | 15.58% | 30 | 11.11% |
| | D | | | | | | | | |
| | E | | | | | | | | |
| | F | | | | | | | | |
| | G | | | | | | | | |
| Precipitated CaCO₃ | | 50 | 16.68% | 50 | 18.52% | | | 50 | 18.52% |
| Ground CaCO₃ | A | 60 | 20.02% | 30 | 11.11% | | | | |
| | B | | | | | | | 30 | 11.11% |
| Titanium Dioxide | | 5 | 1.67% | 5 | 1.85% | | | 5 | 1.85% |
| Carbon Black | | | | 0.25 | 0.09% | 1 | 0.52% | 0.25 | 0.09% |
| Thixotropic agent | | 0.75 | 0.25% | 0.75 | 0.28% | 7.5 | 3.90% | 0.75 | 0.28% |
| UV absorber | | 1 | 0.33% | 1 | 0.37% | 1 | 0.52% | 1 | 0.37% |
| HALS | | 1 | 0.33% | 1 | 0.37% | 1 | 0.52% | 1 | 0.37% |
| Dehydration agent | | 3 | 1.00% | 3 | 1.11% | 3 | 1.56% | 3 | 1.11% |
| Adhesion promoter | | 3 | 1.00% | 3 | 1.11% | 3 | 1.56% | 3 | 1.11% |
| Catalyst | A | | | | | | | | |
| | B | 6 | 2.00% | 6 | 2.22% | 6 | 3.12% | | |
| | C | | | | | | | 6 | 2.22% |
| | D | | | | | | | | |

| | | | | | | | | |
|---|---|---|---|---|---|---|---|---|
| Total | 299.75 | 100% | 270 | 100% | 192.5 | 100% | 270 | 100% |

| | | EX9 | | EX10 | | EX11 | |
|---|---|---|---|---|---|---|---|
| Component | | phr | wt % | phr | wt % | phr | wt % |
| DMS MS Polymer | | 100 | 37.04% | 100 | 37.04% | 100 | 37.04% |
| TMS MS Polymer | | | | | | | |
| Plasticizer | A | | | | | | |
| | B | 40 | 14.81% | | | | |
| | C | 30 | 11.11% | 30 | 11.11% | 30 | 11.11% |
| | D | | | | | | |
| | E | | | | | | |
| | F | | | 40 | 14.81% | | |
| | G | | | | | 40 | 14.81% |
| Precipitated CaCO₃ | | 50 | 18.52% | 50 | 18.52% | 50 | 18.52% |
| Ground CaCO₃ | A | | | | | | |
| | B | 30 | 11.11% | 30 | 11.11% | 30 | 11.11% |
| Titanium Dioxide | | 5 | 1.85% | 5 | 1.85% | 5 | 1.85% |
| Carbon Black | | 0.25 | 0.09% | 0.25 | 0.09% | 0.25 | 0.09% |
| Thixotropic agent | | 0.75 | 0.28% | 0.75 | 0.28% | 0.75 | 0.28% |
| UV absorber | | 1 | 0.37% | 1 | 0.37% | 1 | 0.37% |
| HALS | | 1 | 0.37% | 1 | 0.37% | 1 | 0.37% |
| Dehydration agent | | 3 | 1.11% | 3 | 1.11% | 3 | 1.11% |
| Adhesion promoter | | 3 | 1.11% | 3 | 1.11% | 3 | 1.11% |
| Catalyst | A | | | | | | |
| | B | | | 6 | 2.22% | 6 | 2.22% |
| | C | | | | | | |
| | D | 6 | 2.22 | | | | |

| | | | | | | |
|---|---|---|---|---|---|---|
| Total | 270 | 100% | 270 | 100% | 270 | 100% |

TABLE 2

| | | | |
|---|---|---|---|
| CE1 | CE2 | CE3 | CE4 |

| Component | | phr | wt % | phr | wt % | phr | wt % | phr | wt % |
|---|---|---|---|---|---|---|---|---|---|
| DMS MS Polymer | | 100 | 36.32% | 100 | 40.85% | 100 | 40.85% | 100 | 42.60% |
| TMS MS Polymer | | | | | | | | | |
| Plasticizer | A | 65 | 23.61% | 80 | 32.68% | | | | |
| | B | | | | | 40 | 16.34% | 40 | 17.04% |
| | C | | | | | 40 | 16.34% | 30 | 12.78% |
| | D | | | | | | | | |
| | E | | | | | | | | |
| | F | | | | | | | | |
| | G | | | | | | | | |
| Precipitated CaCO₃ | | 20 | 7.26% | 50 | 20.42% | 50 | 20.42% | 50 | 21.30% |
| Ground CaCO₃ | A | 60 | 21.79% | | | | | | |
| | B | | | | | | | | |
| Titanium Dioxide | | 20 | 7.26% | 5 | 2.04% | 5 | 2.04% | 5 | 2.13% |
| Carbon Black | | | | | | | | | |
| Thixotropic agent | | 1.5 | 0.54% | 1 | 0.41% | 1 | 0.41% | 0.75 | 0.32% |
| UV absorber | | 1 | 0.36% | 1 | 0.41% | 1 | 0.41% | 1 | 0.43% |
| HALS | | 1 | 0.36% | 1 | 0.41% | 1 | 0.41% | 1 | 0.43% |
| Dehydration agent | | 3 | 1.09% | 3 | 1.23% | 3 | 1.23% | 3 | 1.28% |
| Adhesion promoter | | 3 | 1.09% | 3 | 1.23% | 3 | 1.23% | 3 | 1.28% |
| Catalyst | A | 0.8 | 0.29% | 0.8 | 0.33% | 0.8 | 0.33% | 1 | 0.43% |
| | B | | | | | | | | |
| | C | | | | | | | | |
| | D | | | | | | | | |
| | | 275.3 | 100% | 244.8 | 100% | 244.8 | 100% | 234.75 | 100% |

| | | |
|---|---|---|
| CE5 | CE6 | CE7 |

| Component | | phr | wt % | phr | wt % | phr | wt % |
|---|---|---|---|---|---|---|---|
| DMS MS Polymer | | 100 | 37.77% | 100 | 33.93% | 60 | 20.36% |
| TMS MS Polymer | | | | | | 40 | 13.57% |
| Plasticizer | A | | | | | | |
| | B | 40 | 15.11% | 40 | 13.57% | 40 | 13.57% |
| | C | 30 | 11.33% | 30 | 10.18% | 30 | 10.18% |
| | D | | | | | | |
| | E | | | | | | |
| | F | | | | | | |
| | G | | | | | | |
| Precipitated CaCO₃ | | 50 | 18.89% | 50 | 16.96% | 50 | 16.96% |
| Ground CaCO₃ | A | 30 | 11.33% | 60 | 20.36% | 60 | 20.36% |
| | B | | | | | | |
| Titanium Dioxide | | 5 | 1.89% | 5 | 1.70% | 5 | 1.70% |
| Carbon Black | | | | | | | |
| Thixotropic agent | | 0.75 | 0.28% | 0.75 | 0.25% | 0.75 | 0.25% |
| UV absorber | | 1 | 0.38% | 1 | 0.34% | 1 | 0.34% |
| HALS | | 1 | 0.38% | 1 | 0.34% | 1 | 0.34% |
| Dehydration agent | | 3 | 1.13% | 3 | 1.02% | 3 | 1.02% |
| Adhesion promoter | | 3 | 1.13% | 3 | 1.02% | 3 | 1.02% |
| Catalyst | A | 1 | 0.38% | 1 | 0.34% | 1 | 0.34% |
| | B | | | | | | |
| | C | | | | | | |
| | D | | | | | | |
| | | 264.75 | 100% | 294.75 | 100% | 294.75 | 100% |

| | |
|---|---|
| CE8 | CE9 |

| | | | | |
|---|---|---|---|---|
| Component | phr | wt % | phr | wt % |

| DMS MS Polymer | | | 100 | 37.04% | 100 | 37.04% |
|---|---|---|---|---|---|---|
| TMS MS Polymer | | | | | | |
| | Plasticizer | A | | | | |
| | | B | | | 40 | 14.86% |
| | | C | | | 30 | 11.14% |
| | | D | 25 | 9.26% | | |
| | | E | 45 | 16.67% | | |
| | | F | | | | |
| | | G | | | | |
| Precipitated CaCO₃ | | | | | | |
| | Ground CaCO₃ | A | | | 85 | 31.57% |
| | | B | | | | |
| Titanium Dioxide | | | 85 | 31.48% | | |
| Carbon Black | | | 0.25 | 0.09% | 0.25 | 0.09% |
| Thixotropic agent | | | 0.75 | 0.28% | | |
| UV absorber | | | 1 | 0.37% | 1 | 0.37% |
| HALS | | | 1 | 0.37% | 1 | 0.37% |
| Dehydration agent | | | 3 | 1.11% | 3 | 1.11% |
| Adhesion promoter | | | 3 | 1.11% | 3 | 1.11% |
| | Catalyst | A | | | | |
| | | B | 6 | 2.22% | 6 | 2.23% |
| | | C | | | | |
| | | D | | | | |
| | | | 270 | 100% | 269.25 | 100% |

“SAX 350” (DMS MS Polymer) and “SAX 530” (TMS MS Polymer) of Tables 1-1 to 1-3, and 2-1 to 2-3, are moisture-curable silyl-terminated polyester Silyl® SAX 350 (dimethoxysilane (DMS) MS polymer™) and SAX530 (trimethoxysilane (TMS) MS polymer™) resins available from Kancka Corporation.

Plasticizer A, B, and C in Tables 1-1 to 1-3, and 2-1 to 2-3, are diisononyl phthalate (DINP), isodecyl benzoate (MB10), and 1,2-cyclohexane dicarboxylic acid diisononyl ester (DINCH), respectively. Plasticizer D, E, F, and G are parachlorobenzotrifluoride “PCBTF” (Oxsol 100), tris(2-chloroisopropyl) phosphate “TCPP” (Fyrol PCF), tri (ethylene glycol)bis(2-ethylhexanoate) “TEG-EH”, and petroleum distillate plasticizer (Fluid D 170 LPP), respectively. Plasticizer A & C-F are non-benzoate plasticizers.

The boiling point of MB10 (Plasticizer B) is greater than 300° C., while the boiling points of DINP (Plasticizer A) and DINCH (Plasticizer C) are greater than 400° C.

MB10 (Plasticizer B) has a dynamic viscosity of 13 cP when measured with a Brookfield LV viscometer with RV-01 spindle at a temperature of 23° C. at 12 revolutions per minute (rpm), and a dynamic viscosity of 5-15 mPa's (cP) when measured in accordance with ASTM D445 at 20° C.

DINP (Plasticizer A) has a dynamic viscosity of 86 cP when measured with a Brookfield LV viscometer with RV-01 spindle at a temperature of 23° C. at 6 rpm.

DINCH (Plasticizer C) has a dynamic viscosity of 43 cP when measured with a Brookfield LV viscometer with RV-01 spindle at a temperature of 23° C. at 6 rpm.

PCBTF (Plasticizer D) has a dynamic viscosity of 0.79 cP at 25° C., and a boiling point of 138.6° C.

TCPP (Plasticizer E) has a dynamic viscosity of 68.5 cP at 20° C., and a boiling point of 288° C.

TEG-EH (Plasticizer F) has a dynamic viscosity of 17 cP when measured with a Brookfield LV viscometer with RV-01 spindle at a temperature of 23° C. at 12 rpm, and a boiling point of 340° C.

Fluid D 170 LPP (Plasticizer G) has a dynamic viscosity of 15 cP when measured with a Brookfield LV viscometer with RV-01 spindle at a temperature of 23° C. at 12 pm, and a boiling point in a range from 300 to 400° C.

Catalyst A is NEOSTANN U-220H organotin catalyst available from Nitto Kasi Co., Ltd. Catalyst B is TIB KAT K25, available from TIB Chemicals AG. Catalyst C is King K-KAT® 670, available from King Industries Specialty Chemicals. Catalyst D is Tyzor® PITA, available from Dorf Ketal Chemicals India Private Limited. Catalysts B-D are non-tin catalysts.

### Physical Properties—Uncured Resin Compositions

Various physical properties of the resin compositions of EXAMPLES 1-11 and COMPARATIVE EXAMPLES 1-9 were measured as described below. In addition, physical properties of REFERENCE EXAMPLE 1, which is a commercially-available sprayable resin composition, were also measured using the same methods.

Dynamic viscosities of the resin compositions were measured by a Brookfield rotational viscometer (“RV” or “Brookfield” viscosity) with an RV-06 spindle. 250 ml of each resin composition was used to measure the viscosity. The viscosity was measured at a frequency of 1 rpm, 2 rpm, and 10 rpm. The Brookfield Thixotropic Index value of each resin composition was determined by dividing the RV viscosity at 2 rpm by the RV viscosity of the same resin composition at 10 rpm.

Dynamic viscosity of the resin compositions was also measured by a parallel plate rheometer. The diameter of the parallel plates was 15 mm. The viscosity was measured with the gap between the parallel plates of 0.5 mm, at a shear rate of 1000 1/s, and at a temperature of 25° C.

A skin time of the resin composition was determined by placing the resin composition in a container and measuring the time required for a skin to form under 23° C. and 50% relative humidity (RH) condition. The skin time test was conducted on the resin compositions immediately after the components were mixed, and on the resin compositions stored in a sealed container for 4 weeks at a temperature of 50° C.

The specific gravity (SG) of the resin composition was calculated by dividing the wt % of each component by the SG of each component in the resin composition to obtain fractional SG for each component, obtaining the sum of the fractional SG for all components, and dividing 1 by the sum of the fractional SG.

The spray index of the resin composition was calculated using Formula (1) as previously described.

The appreciable presence of noxious odor or lack thereof was confirmed by wafting the resin composition while it was spread out for the castings to prepare cured resin composition samples.

EXAMPLE 6, COMPARATIVE EXAMPLE 1 and REFERENCE EXAMPLE 1 were tested for their spray-ability (spray pattern). The spray pattern of the compositions was evaluated at Graco Spray Lab, using “equipment 1,” which is an airless hydraulic spray rig with Graco 675 Hopper Fed, 50 ft ½″ hose, 10 ft ⅜″ whip and 521 tip at a pressure of 4000 psi.

EXAMPLES 6-11 and COMPARATIVE EXAMPLES 8-9 were also tested for their sprayability (spray pattern). The spray patterns of the compositions were evaluated at Graco Spray Lab, using “equipment 2,” which is Graco X-Force handheld spray gun with 519 tip capable of 4000 psi as a reference tip.

The summary of the uncured resin composition properties of EXAMPLES 1-11 (EX 1-11), COMPARATIVE EXAMPLES 1-9 (CE 1-9), and REFERENCE EXAMPLE 1 (RE 1) are shown in Tables 3-1 to 3-3 and Tables 4-1 to 4-3.

TABLE 3

| | condition | | units | EX1 | EX2 | EX3 | EX4 |
|---|---|---|---|---|---|---|---|
| Viscosity (RV) | 1 | rpm | cP | 33000 | 47000 | 57000 | 64000 |
| | 2 | rpm | cP | 22000 | 31000 | 36000 | 40500 |
| | 10 | rpm | cP | 9300 | 13700 | 14800 | 16600 |
| Brookfield | | | 2 rpm/10 rpm | 2.37 | 2.26 | 2.43 | 2.44 |
| Thixotropic Index | | | | | | | |
| Rheometer - 15 mm | 1000 | 1/s | Pa*s | 2.01 | 2.23 | 2.46 | 3.22 |
| parallel plate (0.5 | | | | | | | |
| mm gap, 25° C.) | | | | | | | |
| Skin time | | | min. | 91 | 125 | 123 | 119 |
| Skin time after | | | min. | 91 | 102 | 100 | 98 |
| storage (4 wks @ | | | | | | | |
| 50° C.) | | | | | | | |
| Specific Gravity | | | Calculated | 1.24 | 1.16 | 1.24 | 1.31 |
| Noxious Odor | | | Yes or No | No | No | No | No |
| Spray Pattern | at 4000 psi | | ◯—acceptable | | | | |
| (equipment 1) | | | X—unacceptable | | | | |
| Spray Pattern | at 4000 psi | | ◯—acceptable | | | | |
| (equipment 2) | | | X—unacceptable | | | | |
| Spray Index | | | | 1.05 | 1.14 | 1.25 | 1.73 |
| | condition | | units | EX5 | EX6 | EX7 | EX8 |
| Viscosity (RV) | 1 | rpm | cP | 53000 | 51000 | 113000 | 102000 |
| | 2 | rpm | cP | 33500 | 32000 | 67500 | 60500 |
| | 10 | rpm | cP | 13000 | 13300 | 23100 | 20700 |
| Brookfield | | | 2 rpm/10 rpm | 2.58 | 2.41 | 2.92 | 2.92 |
| Thixotropic Index | | | | | | | |
| Rheometer - 15 mm | 1000 | 1/s | Pa*s | 2.66 | 2.40 | 2.45 | 2.29 |
| parallel plate (0.5 | | | | | | | |
| mm gap, 25° C.) | | | | | | | |

| | | | | | | |
|---|---|---|---|---|---|---|
| Skin time | | min. | 118 | 100 | 90 | 86 |
| Skin time after | | min. | 100 | 128 | 150 | 60 |
| storage (4 wks @ | | | | | | |
| 50° C.) | | | | | | |
| Specific Gravity | | Calculated | 1.31 | 1.24 | 0.98 | 1.23 |
| Noxious Odor | | Yes or No | No | No | No | No |
| Spray Pattern | at 4000 psi | ◯—acceptable | | ◯* | | |
| (equipment 1) | | X—unacceptable | | | | |
| Spray Pattern | at 4000 psi | ◯—acceptable | | ◯* | ◯ | ◯ |
| (equipment 2) | | X—unacceptable | | | | |
| Spray Index | | | 1.35 | 1.23 | 0.82 | 0.96 |

| | condition | | units | EX9 | EX10 | EX11 |
|---|---|---|---|---|---|---|
| Viscosity (RV) | 1 | rpm | cP | 60000 | 48000 | 62000 |
| | 2 | rpm | cP | 36500 | 30000 | 38000 |
| | 10 | rpm | cP | 13500 | 12000 | 14300 |
| Brookfield | | | 2 rpm/10 rpm | 2.70 | 2.50 | 2.66 |
| Thixotropic Index | | | | | | |
| Rheometer - 15 mm | 1000 | 1/s | Pa*s | 2.15 | 2.33 | 2.19 |
| parallel plate (0.5 | | | | | | |
| mm gap, 25° C.) | | | | | | |

| | | | | | |
|---|---|---|---|---|---|
| Skin time | | min. | >1440 | 111 | 110 |
| Skin time after | | min. | >1440 | 85 | 85 |
| storage (4 wks @ | | | | | |
| 50° C.) | | | | | |
| Specific Gravity | | Calculated | 1.23 | 1.24 | 1.20 |
| Noxious Odor | | Yes or No | No | No | No |
| Spray Pattern | at 4000 psi | ◯—acceptable | | | |
| (equipment 1) | | X—unacceptable | | | |
| Spray Pattern | at 4000 psi | ◯—acceptable | ◯ | ◯ | ◯ |
| (equipment 2) | | X—unacceptable | | | |
| Spray Index | | | 0.98 | 1.15 | 0.99 |

*Spray pattern obtained using the exact same formulation, blended in a subsequent batch

TABLE 4

| | condition | | units | CE1 | CE2 | CE3 | CE4 |
|---|---|---|---|---|---|---|---|
| Viscosity (RV) | 1 | rpm | cP | 125000 | 117000 | 97000 | 93000 |
| | 2 | rpm | cP | 76500 | 69000 | 58000 | 53500 |
| | 10 | rpm | cP | 28900 | 23700 | 19800 | 18300 |
| Brookfield | | | 2 rpm/10 rpm | 2.65 | 2.91 | 2.93 | 2.92 |
| Thixotropic Index | | | | | | | |
| Rheometer - 15 mm | 1000 | 1/s | Pa*s | 4.21 | 3.09 | 1.71 | 1.91 |
| parallel plate (0.5 | | | | | | | |
| mm gap, 25° C.) | | | | | | | |

| | | | | | | |
|---|---|---|---|---|---|---|
| Skin time | | min. | 112 | 117 | 115 | 91 |
| Skin time after | | min. | >300 | >300 | >300 | >300 |
| storage (4 wks @ | | | | | | |
| 50° C.) | | | | | | |
| Specific Gravity | | Calculated | 1.30 | 1.16 | 1.15 | 1.57 |
| Noxious Odor | | Yes or No | No | No | Yes | Yes |
| Spray Pattern | at 4000 psi | ◯—acceptable | X* | | | |
| (equipment 1) | | X—unacceptable | | | | |
| Spray Pattern | at 4000 psi | ◯—acceptable | | | | |
| (equipment 2) | | X—unacceptable | | | | |
| Spray Index | | | 2.07 | 1.23 | 0.67 | 1.03 |

| | condition | | units | CE5 | CE6 | CE7 |
|---|---|---|---|---|---|---|
| Viscosity (RV) | 1 | rpm | cP | 116000 | 153000 | 144000 |
| | 2 | rpm | cP | 67500 | 87500 | 82000 |
| | 10 | rpm | cP | 22500 | 28500 | 26000 |
| Brookfield | | | 2 rpm/10 rpm | 3.00 | 3.07 | 2.67 |
| Thixotropic Index | | | | | | |
| Rheometer - 15 mm | 1000 | 1/s | Pa*s | 2.17 | 2.76 | 2.67 |
| parallel plate (0.5 | | | | | | |
| mm gap, 25° C.) | | | | | | |

| | | | | | |
|---|---|---|---|---|---|
| Skin time | | min. | 90 | 86 | 14 |
| Skin time after | | min. | >300 | >300 | 203 |
| storage (4 wks @ | | | | | |
| 50° C.) | | | | | |
| Specific Gravity | | Calculated | 1.24 | 1.31 | 1.31 |
| Noxious Odor | | Yes or No | Yes | Yes | Yes |
| Spray Pattern | at 4000 psi | ◯—acceptable | | | |
| (equipment 1) | | X—unacceptable | | | |
| Spray Pattern | at 4000 psi | ◯—acceptable | | | |
| (equipment 2) | | X—unacceptable | | | |
| Spray Index | | | 0.89 | 1.18 | 1.11 |

| | condition | | units | CE8 | CE9 | RE1 |
|---|---|---|---|---|---|---|
| Viscosity (RV) | 1 | rpm | cP | 20000 | 2000 | 25000 |
| | 2 | rpm | cP | 16500 | 2000 | 18500 |
| | 10 | rpm | cP | 10300 | 2000 | 9300 |
| Brookfield | | | 2 rpm/10 rpm | 1.60 | 1.00 | 1.99 |
| Thixotropic Index | | | | | | |
| Rheometer - 15 mm | 1000 | 1/s | Pa*s | 3.17 | 2.42 | 3.28 |
| parallel plate (0.5 | | | | | | |
| mm gap, 25° C.) | | | | | | |

| | | | | | |
|---|---|---|---|---|---|
| Skin time | | min. | 92 | 174 | 75 |
| Skin time after | | min. | 150 | 95 | 135 |
| storage (4 wks @ | | | | | |
| 50° C.) | | | | | |
| Specific Gravity | | Calculated | 1.42 | 1.23 | 1.35 |
| Noxious Odor | | Yes or No | No | No | No |
| Spray Pattern | at 4000 psi | ◯—acceptable | | | X |
| (equipment 1) | | X—unacceptable | | | |
| Spray Pattern | at 4000 psi | ◯—acceptable | X | X | |
| (equipment 2) | | X—unacceptable | | | |
| Spray Index | | | 2.82 | 2.97 | 2.23 |

*Spray pattern obtained using the exact same formulation, blended in a subsequent batch

Tables 3-1 to 3-3, and 4-1 to 4-3, also show that the skin times of EXAMPLES 1-11 remained approximately the same immediately after the production of the compositions, and after 4-week storage at 50° C., indicating that the compositions of EXAMPLES 1-11 have substantial shelf life. Meanwhile, the skin times of COMPARATIVE EXAMPLES 1-8 and REFERENCE EXAMPLE 1 increased substantially after 4-week storage.

None of EXAMPLES 1-11 exhibited noxious odor, while COMPARATIVE EXAMPLES 3-7 which contain organotin catalyst resulted in generation of noxious odor.

EXAMPLE 6 demonstrated an acceptable spray pattern while COMPARATIVE EXAMPLE 1 and REFERENCE EXAMPLE 1 had unacceptable spray pattern.

Combined together, above test results indicate that EXAMPLES 1-11 are suitable as sprayable curable resin compositions.

### Physical Properties—Cured Resin Compositions

Test samples of cured resin compositions were prepared from the resin compositions of EXAMPLE 1-11, COMPARATIVE EXAMPLES 1-9, and REFERENCE EXAMPLE 1, and physical properties of the cured resin compositions were obtained as described below. The test samples were prepared by casting each resin composition into a mold, curing under a condition of 23° C. and 50% RH for 3 days to permit moisture penetration, and further curing under a condition at 50° C. for 4 days to ensure cure completion.

The specific gravity (SG) of the cured resin compositions were determined as previously described.

The permeabilities of the cured test samples were obtained in accordance with ASTM E96. A 4″×4″ test specimen for each, having a thickness of approximately 1 mm (the thickness was measured with Peacock Model PDN-21), was placed on a cup filled with water. The cup was then sealed to prevent vapor loss except through the test specimen. The initial weight of the apparatus (which includes the cup, water, seal and the test specimen) was measured along with the temperature and relative humidity for that day, and the weight of the apparatus was weighed over the period of 7 days. The amount of evaporated water was determined by subtracting the final weight of the apparatus from the initial weight of the apparatus. The permeability was calculated according to the calculation specified in ASTM E96.

The summary of the cured resin composition properties of EXAMPLES 1-11 (EX 1-11), COMPARATIVE EXAMPLES 1-9 (CE 1-9), and REFERENCE EXAMPLE 1 (RE 1) are shown in Tables 5-1 to 5-4, and 6-1 to 6-3.

TABLE 5

| | condition | units | EX1 | EX2 | EX3 | EX4 | EX5 | EX6 | EX7 | EX8 | EX9 | EX10 | EX11 |
|---|---|---|---|---|---|---|---|---|---|---|---|---|---|
| Specific Gravity | Calculated | | 1.24 | 1.16 | 1.24 | 1.31 | 1.31 | 1.24 | 0.98 | 1.23 | 1.23 | 1.24 | 1.20 |
| Permeability (wet cup) | ASTM E96 | perm*inch | 0.39 | 0.42 | 0.32 | 0.29 | 0.32 | 0.49 | 0.48 | 0.52 | 0.42 | 0.68 | 0.59 |

TABLE 6-1

| | condition | units | CE1 | CE2 | CE3 | CE4 |
|---|---|---|---|---|---|---|
| Specific Gravity | Calculated | | 1.30 | 1.16 | 1.15 | 1.57 |
| Permeability (wet cup) | ASTM E96 | perm*inch | 0.29 | 0.24 | 0.33 | 0.28 |

| | | | | |
|---|---|---|---|---|
| condition | units | CE5 | CE6 | CE7 |

| | | | | |
|---|---|---|---|---|
| Specific Gravity | Calculated | 1.24 | 1.31 | 1.31 |

| Permeability (wet cup) | ASTM E96 | perm*inch | 0.34 | 0.29 | 0.24 |
|---|---|---|---|---|---|
| | condition | units | CE8 | CE9 | RE1 |

| | | | | |
|---|---|---|---|---|
| Specific Gravity | Calculated | 1.42 | 1.23 | 1.35 |

| | | | | | |
|---|---|---|---|---|---|
| Permeability (wet cup) | ASTM E96 | perm*inch | 1.07 | 1.97 | 0.48 |

Tables 5-1 to 5-4 shows that the permeability of cured resin samples produced from resin compositions of EXAMPLES (EX) 1-11 are greater than 0.20 perm*inch, which would correspond to over 10 perm at 20 mil thickness. The permeability results of EX 1-11 demonstrate that the moisture curable compositions containing non-tin catalyst(s) provide sufficient breathability and good drying performance, which is desirable from a mold growth prevention standpoint.

The cured resin composition test results of EX 1-11 in Tables 5-1 to 5-4, CE 1-9 and RE 1 in Table 6-1 to 6-3, also show that the cured resin compositions including non-tin catalyst(s) provide equivalent specific gravity to the cured resin composition containing tin-based catalyst(s). Therefore, the results demonstrate that the incorporation of non-tin catalyst does not negatively affect the specific density or the tackiness of the cured resin composition compared to the resin composition containing tin-based catalyst.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A curable resin composition, comprising:
10 wt % to 70 wt % of at least one moisture curable resin;
10 wt % to 50 wt % of at least one plasticizer having a Brookfield viscosity of less than 25 cP at 23° C., and
0.1 wt % to 5 wt % of a non-tin catalyst.

2. The curable resin composition of claim 1, wherein the at least one moisture curable resin comprises reactive silicon groups represented by the general formula (1):
—Si(R¹₃₋ₐ)Xₐ
wherein R¹ represents an alkyl group having 1 to 20 carbon atoms, an aryl group having 6 to 20 carbon atoms, or an aralkyl group having 7 to 20 carbon atoms,
wherein X represents a hydrolyzable group, wherein each X is the same or different when two or more X are present,
a is an integer from 1 to 3, when a is 1, each R¹ may be the same or different, and
when a is 2 or 3, each X may be the same or different.

3. The curable resin composition of claim 1, wherein the at least one moisture curable resin comprises a silyl-terminated polyether.

4. The curable resin composition of claim 1, wherein the non-tin catalyst comprises potassium neodecanoate.

5. The curable resin composition of claim 1, wherein the at least one plasticizer comprises at least one of a benzoate, a phthalate, a cyclohexyl diester, a glycol diester, and a petroleum distillate.

6. The curable resin composition of claim 1, wherein the at least one plasticizer is substantially free of volatile organic compounds.

7. The curable resin composition of claim 1, wherein the at least one plasticizer has a boiling point of at least 260° C.

8. The curable resin composition of claim 1, wherein a content of the moisture curable resin and the plasticizer is in a range of 20 wt % to 90 wt % of the curable resin composition.

9. The curable resin composition of any claim 1, wherein the curable resin composition is sprayable with an airless hydraulic spray rig or a pressurized canister at a pressure of 4000 psi or less.

10. The curable resin composition of claim 1, having a viscosity of less than 75,000 cP at 2 rpm, as measured by a rotational viscometer.

11. The curable resin composition of claim 1, having a viscosity of less than 25,000 cP at 10 rpm, as measured by a rotational viscometer.

12. The curable resin composition of claim 1, having a viscosity of less than 3.5 Pas at a temperature of 25° C. and a shear rate of 1000 1/s, as measured by a parallel plate rheometer.

13. The curable resin composition of claim 1, having a skin time of less than 150 minutes at 23° C. and 50% relative humidity.

14. The curable resin composition of claim 1, having a skin time at 23° C. and 50% relative humidity of less than 150 minutes, after 4-week storage at 50° C.

15. The curable resin composition of claim 1, free of noxious odor.

16. The curable resin composition of claim 1, having a spray index of 2.0 or less.

17. The curable resin composition of claim 1, further comprising at least one higher viscosity plasticizer having a Brookfield viscosity of at least 25 cP at 23° C.

18. A cured resin composition of the curable resin composition of claim 1.

19. The cured resin composition of claim 18, having a permeability of more than 0.20 perm*inch, according to ASTM E96.

20. The cured resin composition of claim 18, having a specific gravity in a range of from 1.10 to 1.60.
